(19) United States
(12) Patent Application Publication
(10) Pub. No.: US 2003/0178002 A1
(43) Pub. Date: Sep. 25, 2003

(54) Apparatus and method to operate an engine exhaust brake together with an exhaust gas recirculation system

(76) Inventors: Mark A. Israel, Amherst, MA (US); John P. Hartley, Blaine, WA (US)

Correspondence Address: Liniak Berenato & White, Suite 240, 6550 Rock Spring Drive, Bethesda, MD, 20817, US

(21) Appl. No.: 10/362,832

(22) PCT Filed: Aug. 24, 2001
(86) PCT No.: PCT/CA01/01223

(51) Int. Cl. F02D 13/04

(52) U.S. Cl. 123/321; 123/323; 123/568.12; 123/568.21; 60/605.2

(57) ABSTRACT

A compression release engine brake apparatus and method for an internal combustion engine includes an exhaust gas recirculator that is connectable between the exhaust outlet and the intake manifold of the engine. The exhaust gas recirculator is operative during operation of the engine brake apparatus to recirculate at least a portion of exhaust gases from the exhaust outlet to the intake manifold to increase charging of the cylinders of the engine prior to the compression stroke. Preferably there is an exhaust restrictor downstream of the exhaust outlet. The engine preferably includes a turbocharger downstream of the exhaust outlet. The exhaust restrictor may be a restrictive turbocharger. Preferably there is an exhaust gas cooler connectable between the exhaust outlet and the intake manifold. This process optimizes engine brake performance and is an effective control for exhaust pressure and temperature and for turbocharger speed.

### BACKGROUND OF THE INVENTION

This invention relates to engine brake apparatuses and methods and, in particular, to engine brake apparatuses and methods having Exhaust Gas Recirculation (EGR).

Equipment to provide engine braking by altering exhaust valve actuation has been known since the 1950s. A standard compression release brake opens each exhaust valve just prior to top dead center (TDC) of the compression stroke. The compressed gas within the cylinder is subsequently released to the exhaust system instead of expanding back into the cylinder during the subsequent expansion stroke. This blow-down process prevents the energy used to compress the gases from being reclaimed.

Methods and apparatuses have been developed to enhance engine brake power by supercharging each cylinder of the engine before the compression release. U.S. Pat. No. 4,848,289 to Meneely introduced a system which combines an exhaust brake with an engine brake. The exhaust brake provides a restriction to exhaust flow, thereby increasing exhaust pressure. A pressure pulse from an adjacent cylinder in the same manifold is superimposed on the higher average exhaust pressure. This generates enough force to temporarily open the exhaust valves against exhaust valve spring pre-load near Bottom Dead Center (BDC) of the compression stroke. The high-pressure gas in the exhaust manifold supercharges the cylinder just before the brake event. Compression begins at a higher cylinder pressure and is compressed to a higher peak value for the blow-down. In addition, an exhaust brake component is provided by virtue of the high exhaust pressure with the operation of the exhaust brake. The recirculation of the hot exhaust gases and the reduction of total mass flow through the engine can cause the exhaust temperature to become very high and care must be taken not to exceed the system limit.

The prior art also reveals engine braking apparatuses that introduce a controlled opening of each exhaust valve around BDC of the compression stroke. The supercharging by reverse flow to the cylinder from the exhaust can occur even when adjacent exhaust pulses are not high enough to overcome the pressure of the exhaust springs. This is useful as long as the exhaust pressure is greater than the intake manifold pressure. Japanese Patent No. 63025330 to Masato discloses such a system. Variations were later disclosed in U.S. Pat. No. 4,981,119 to Neitz, U.S. Pat. No. 5,146,890 to Gobert and U.S. Pat. No. 5,586,531 to Vittorio.

The systems actuate the additional exhaust valve opening (BGR) with an additional lift on the exhaust cam profile around BDC of the compression stroke. To distinguish from the positive power EGR process, during engine breaking the term Brake Gas Recirculation (BGR) is used. They use lash adjustment mechanisms to prevent BGR during positive power operation of the engine. Significant enhancement of the retarding power can be achieved. However, circulation of the hot exhaust gases and the reduction of mass flow through the engine can produce very high exhaust temperatures. The amount of this “Hot BGR” must be limited in order not to exceed system temperature limits.

U.S. Pat. No. 6,170,474 to Israel discloses a method for exhaust pressure regulation by controlling an internal exhaust gas recirculation process. The control is carried out responsive to monitored levels of exhaust pressure and/or temperature. A restriction is placed in the exhaust system to raise exhaust pressure. A re-opening of the engine exhaust valves is introduced to provide passage for exhaust gas to reenter the cylinder from the exhaust manifold. This simultaneously relieves exhaust system pressure and supercharges the cylinder for engine braking. By controlling the timing and magnitude of this event, exhaust pressure is regulated.

U.S. Pat. No. 6,230,382 to Gustafsson et al. discloses a system to shorten the warm-up time for an engine and reduce emissions by restricting exhaust gas from exiting the engine and redirecting a portion to the intake system by way of the engine's external EGR system. Controls disable this function once steady state operation is reached.

Where exhaust gas restriction is provided by a variable geometry turbocharger, high exhaust pressure upstream of the turbine represents a large pressure difference across the turbine. This may generate excessive turbocharger speed and therefore exhaust pressure may need to be limited.

Engines equipped with external EGR systems generally have a smaller flow capacity turbocharger compressor. This match is designed to incorporate the additional internal mass flow provided by the FGR. If the EGR is turned off, the total engine mass flow is limited to the choked flow capacity of the compressor.

It is an object of the invention to provide an improved engine braking apparatus and method that give increased braking power compared with conventional engine brakes.

It is also an object of the invention to provide an improved engine braking apparatus and method for use when the exhaust pressure is insufficient to counter the force of the exhaust valve springs.

It is another object of the invention to provide an improved engine braking apparatus and method that enhance engine brake power, but avoids high thermal loading of the engine.

It is a further object of the invention to provide an improved engine braking apparatus and method where the braking is enhanced for the entire engine speed range when the brake is utilized.

It is a still further object of the invention to provide an improved engine braking apparatus and method for engines with turbochargers where the turbocharger speed is maintained within design limits.

It is a still further object of the invention to provide an improved engine braking apparatus and method for engines with exhaust gas recirculation systems.

### SUMMARY OF THE INVENTION

There is provided, according to an embodiment of the invention, a compression release brake apparatus for an internal combustion engine having a plurality of cylinders with a compression stroke. The engine has an exhaust outlet and an exhaust manifold. The apparatus includes an exhaust gas recirculator that is connectable between the exhaust outlet and the exhaust manifold. The exhaust gas recirculator is operative during operation of the engine brake apparatus to recirculate at least a portion of exhaust gases from the exhaust outlet to the intake manifold to increase charging of the cylinders of the engine prior to the compression stroke.

The apparatus may include an exhaust restrictor downstream of the exhaust outlet.

The engine may include a turbocharger downstream of the exhaust outlet. The exhaust restrictor may be a restrictive turbocharger.

There may be an exhaust gas cooler connectable between the exhaust outlet and the intake manifold.

According to another aspect of the invention, there is provided a method for braking an internal combustion engine having a plurality of cylinders, each cylinder having a compression stroke. The engine has an exhaust outlet, an intake manifold and a compression release brake. The method comprises fitting the engine with an external exhaust gas recirculation conduit between the exhaust outlet and the intake manifold. At least a portion of the exhaust gases are recirculated from the exhaust outlet to the intake manifold during brake operation to increase charging of the cylinders of the engine prior to the compression stroke.

The exhaust is typically restricted downstream of the exhaust outlet. The exhaust may be restricted by placing a turbocharger downstream of the exhaust outlet. The exhaust may also be restricted between the exhaust outlet and a turbocharger.

Preferably the exhaust gases are cooled between the exhaust outlet and the intake manifold.

The invention offers significant advantages compared with prior art engine braking apparatuses and methods. Unlike some prior art devices and methods, it does not require a special internal engine mechanism apart from a conventional engine brake. On the other hand, the invention is useful for applications where the exhaust pressure is insufficient to counter the pressure of the exhaust valve springs in order to enhance the charges of the cylinders prior to compression. At the same time, engine operation can be maintained within specified thermal limits and the speed of the turbocharger can similarly be confined within operational parameters. The cylinder charge of the engine is enhanced throughout the operational speed range of the engine during engine braking.

### BRIEF DESCRIPTION OF THE DRAWINGS

In the drawings:

FIG. 1 is a diagrammatic view of a turbocharged engine with an external EGR system and an exhaust restrictor downstream of the turbocharger;

FIG. 2 is a view similar to FIG. 1 with an exhaust restrictor upstream of the turbocharger;

FIG. 3 is a graph plotting cylinder mass against crank angle for engines having no BGR, hot BGR and cooled BGR;

FIG. 4 is a table showing engine performance comparisons for the three engines of FIG. 3; and

FIG. 5 is a control algorithm flowchart for operation of the EGR valve during engine braking.

### DETAILED DESCRIPTION OF THE PREFERRED EMBODIMENTS

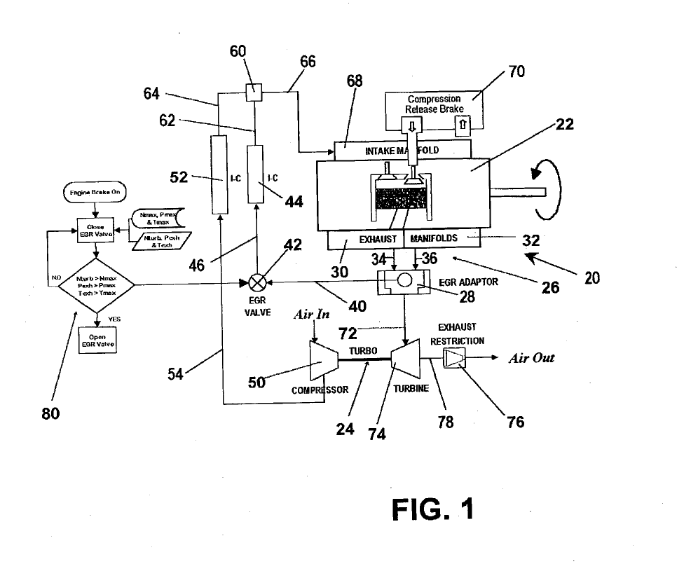

Referring to the drawings, and first to FIG. 1, this shows an engine apparatus 20 including an internal combustion engine 22 equipped with a turbocharger 24. The engine is also provided with an external EGR system 26. This may comprise an original part of the vehicle where the engine is equipped with an EGR system or may be added to engines that are not so equipped. There is an adapter 28 connected to exhaust manifolds 30 and 32 of the engine by exhaust ports 34 and 36 which comprise the exhaust manifold outlets in this embodiment. An exhaust conduit 40 connects the adapter to a valve 42. The valve is connected to a cooler 44 by conduit 46. The turbocharger has a compressor 50, which is connected to another cooler 52 by conduit 54. Coolers 44 and 52 are connected to a fitting 60 by conduits 62 and 64 respectively. A conduit 66 connects the fitting 60 to intake manifold 68 of the engine. The engine is provided with a compression release brake 70. The compression release brake may be the type that holds the cylinder charge until late in the compression stroke before releasing the charge. It may also be the type that releases the cylinder charge over most or all of the compression stroke and up to the beginning of the main exhaust valve opening.

An exhaust conduit 72 connects the adapter 28 to turbine 74 of the turbocharger. There is an exhaust restrictor 76 connected downstream of the turbocharger 24 by conduit 78.

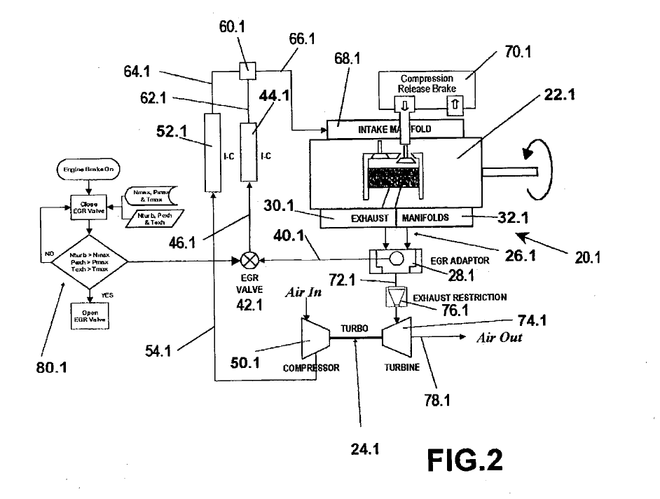

FIG. 2 illustrates an alternative embodiment where like parts have like numbers as in FIG. 1 with the additional designation “. 0.1”. In this embodiment however exhaust restrictor 76.1 is upstream of turbocharger 24.1 and is located between the turbocharger and adapter 28.1.

Referring to FIG. 1, during normal engine operation adapter 28 serves as an EGR adapter and valve 42 acts as an EGR valve. When the valve 42 is closed, air flows through the engine normally from the intake side and leaves the engine through exhaust ports 34 and 36. However, when the valve 42 opens, a portion of the exhaust gas is directed away from turbine 74 of turbocharger 24 towards cooler 44 through conduits 40 and 46. This portion of the exhaust is mixed with fresh air in the intake manifold 68.

The exhaust restrictors 76 and 76.1 described above are used to increase the exhaust pressure in the engine. The flow of exhaust gas from the exhaust side to the intake manifold requires that the exhaust pressure be higher than the intake pressure. To achieve this, the exhaust restrictor, or some other restriction, is placed in the exhaust system downstream of the exhaust manifold. Other restrictors could include an exhaust brake or a highly restrictive turbocharger. The turbocharger may be a fixed geometry type, with or without a wastegate, or a variable geometry type. The restriction can be placed before the turbocharger turbine, as shown in FIG. 1, or after the turbocharger turbine as seen in FIG. 2. Having the restriction installed upstream of the turbine is advantageous because it generates a high pressure differential across the turbine. Thus the turbocharger compressor is driven at a high speed and provides more intake boost for compression and release.

Adapter 28 and valve 42, when open, serve to divert some of the exhaust gas away from turbocharger 24 towards the intake system through manifold 68. Exhaust system pressure is developed as the mass of exhaust gases is pumped by the engine through the restriction near the exit of the engine comprising restrictor 76 or 76.1 and/or turbocharger 24 or 24.1.

Cooler 52 is a conventional inter-cooler for air exiting compressor 50 prior to the air entering manifold 68. Cooler 44 is similar to inter-cooler 52, but smaller in this example because the volume of exhaust gases recirculated through the cooler is normally less than the volume of air expelled by the compressor. Alternatively, both coolers could be combined, but would be larger in capacity than the normal cooler 52.

The turbocharger 24 or 24.1 is preferably a variable geometry type for maximum performance engine braking. The flow area of the turbine is reduced to operate the turbocharger for maximum boost pressure in the intake system. As a result, a significant exhaust pressure is produced upstream of the turbine. As engine speed increases, turbine speed also increases due to the increasing pressure difference across the turbine. The valve 42 or 42.1 is opened once the turbine speed limit is reached. This relieves the pressure built up in the exhaust. A portion of the mass flow is redirected through the cooler 44 or 44.1 to the intake manifold where it mixes with incoming fresh air from the compressor. The result is an increased boost level in the intake manifold to increase the charge of each cylinder during the intake stroke to achieve increased engine braking during the subsequent compression stroke.

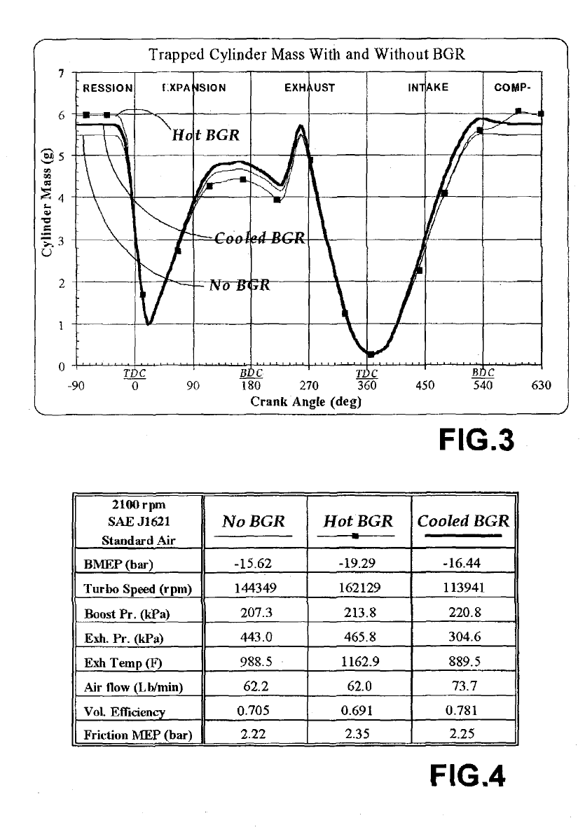

FIG. 3 shows a comparison of the cylinder mass charging for the same engine with no BGR, hot BGR, and cooled BGR. The system is operating at 2100 rpm. FIG. 4 is a table showing the performance data for the same three systems. The system operating with cooled BGR is optimized to provide the maximum engine braking power while maintaining the turbocharger speed below its maximum limit of 115,000 rpm for this example. T his is accomplished at significantly lower exhaust pressure and temperature. The effective air mass flow through the engine is increased 18.5 percent and is reflected in the volumetric efficiency.

For hot BGR, the cylinder supercharging occurs around BDC compression due to a significantly higher mass level than the baseline system with no BGR. After the compression release around TDC, the cylinder refills from the exhaust manifold during the main opening of the exhaust valve. With hot BGR, the cylinder fills with less mass, but much higher temperature maintains exhaust pressure and pumping work at a high level.

With cooled BGR, exhaust temperature and pressure are lower. The cylinder is charged for compression release from the exhaust to a higher level than the base system. The cooler air also charges the cylinder to a higher level of mass during the main opening of the exhaust valve. The pumping work component of engine braking is maintained at the level of the higher exhaust pressure without BGR.

With the cooled BGR, mass is diverted from the exhaust manifold and the exhaust back pressure drops. The resulting lower exhaust temperature and turbine pressure difference drive the turbine at a lower speed. The valve 42 or 42.1 is adjusted by the controls to maintain acceptable turbocharger speed.

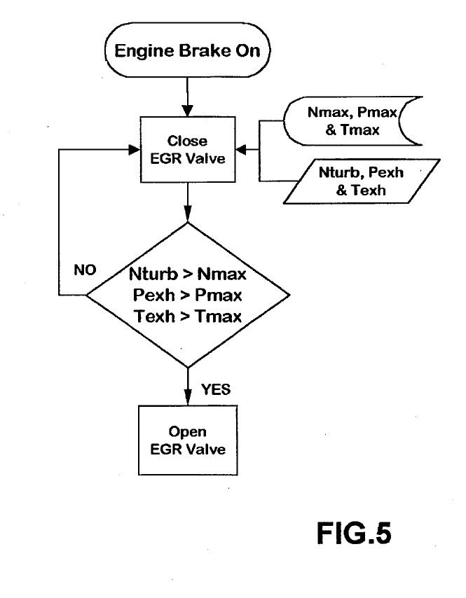

FIG. 5 is a flowchart of the control algorithm for operation of the EGR valve during engine braking. The control parameters are turbine speed (Nturb), exhaust pressure (Pexh) and exhaust temperature (Texh). The control system is item 80 and 80.1 in FIGS. 1 and 2 respectively. As the engine brake is turned on, the ECIR valve 42 or 42.1 is closed. Maximum values for turbine speed (Nmax), exhaust pressure (Pmax) and exhaust temperature (Tmax) are stored in a microprocessor. These are reference values to check against the measured values of the control parameters. If all the measured values are less than the reference values, the EGR valve remains closed. As soon as any of the control parameters exceeds a reference limit, the EGR valve is opened. This provides exhaust pressure relief and the exceeded parameter is brought back to below the limit. The excess mass that is diverted away from the turbine is directed through the EGR cooler to the intake system.

It would be understood by someone skilled in the art that many of the above details are provided by way of example only and are not intended to limit the scope of the invention, which is to be interpreted with reference to the following claims:

What is claimed is:

1. A compression release engine brake apparatus for an internal combustion engine having a plurality of cylinders with a compression stroke, the engine having an exhaust manifold outlet and an intake manifold, the apparatus comprising:
an exhaust gas recirculator connectable between the exhaust outlet and the intake manifold, the exhaust gas recirculator being operative during operation of the engine brake apparatus to recirculate at least a portion of exhaust gases from the exhaust outlet to the intake manifold to increase charging of the cylinders of the engine prior to the compression stroke.

2. The compression release engine brake apparatus as claimed in claim 1, including controls which operate the exhaust gas recirculator during operation of the compression release brake.

3. The compression release brake apparatus as claimed in claim 1, including means for operating the exhaust gas recirculator during operation of the compression release brake.

4. The compression release engine brake apparatus as claimed in claim 1, including an exhaust restrictor downstream of the exhaust manifold outlet.

5. The compression release engine brake apparatus as claimed in claim 4, wherein the engine includes a turbocharger downstream of the exhaust manifold outlet.

6. The compression release engine brake apparatus as claimed in claim 5, wherein the exhaust gas restrictor is downstream of the turbocharger.

7. The compression release engine brake apparatus as claimed in claim 5, wherein the exhaust restrictor is operatively disposed between the exhaust manifold outlet and the turbocharger.

8. The compression release brake apparatus as claimed in claim 4, wherein the exhaust restrictor is a restrictive turbocharger.

9. The compression release brake apparatus as claimed in claim 1, including an exhaust gas cooler connectable between the exhaust manifold outlet and the intake manifold.

10. The compression release brake apparatus as claimed in claim 5, wherein the turbocharger has a turbine, the brake apparatus including controls which operate the exhaust gas recirculator when at least one of the following occurs: (1) pressure of exhaust from the engine exceeds a predetermined value, (2) temperature of exhaust from the engine exceeds a predetermined value or (3) rotational speed of the turbine exceeds a predetermined value.

11. The compression release brake apparatus as claimed in claim 10, wherein the controls include memory for storing the predetermined values of the pressure of exhaust, temperature of exhaust and rotational speed of the turbine.

12. An internal combustion apparatus having an exhaust manifold outlet, an intake manifold, a compression release brake and a plurality of cylinders, each said cylinder having a compression stroke, the apparatus including an exhaust gas recirculator connected between the exhaust outlet and the intake manifold, the exhaust gas recirculator being operative during operation of the engine brake apparatus to recirculate at least a portion of the exhaust gases from the exhaust outlet to the intake manifold to increase charging of the cylinders prior to the compression stroke.

13. The internal combustion apparatus as claimed in claim 12 including an internal combustion engine having the exhaust manifold outlet and the intake manifold.

14. The internal combustion apparatus as claimed in claim 12, including controls which operate the exhaust gas recirculator during operation of the compression release brake.

15. The compression release brake apparatus as claimed in claim 12, including means for operating the exhaust gas recirculator during operation of the compression release brake.

16. The apparatus as claimed in claim 13, including an exhaust restrictor downstream of the exhaust manifold outlet.

17. The apparatus as claimed in claim 16, wherein the engine includes a turbocharger downstream of the exhaust manifold outlet.

18. The apparatus as claimed in claim 17, wherein the exhaust gas restrictor is downstream of the turbocharger.

19. The apparatus as claimed in claim 17, wherein the exhaust restrictor is operatively disposed between the exhaust manifold outlet and the turbocharger.

20. The apparatus as claimed in claim 16, wherein the exhaust restrictor is a restrictive turbocharger.

21. The apparatus as claimed in claim 12, including an exhaust gas cooler connectable between the exhaust manifold outlet and the intake manifold.

22. The apparatus as claimed in claim 17, wherein the turbocharger has a turbine, the brake apparatus including controls which operate the exhaust gas recirculator when at least one of the following occurs: (1) pressure of exhaust from the engine exceeds a predetermined value, (2) temperature of exhaust from the engine exceeds a predetermined value or (3) rotational speed of the turbine exceeds a predetermined value.

23. The apparatus as claimed in claim 22, wherein the controls include memory for storing the predetermined values of the pressure of exhaust, temperature of exhaust and rotational speed of the turbine.

24. A method for braking an internal combustion engine having a plurality of cylinders, each having a compression stroke, the engine having an exhaust manifold outlet, an intake manifold and a compression release brake, the method comprising:
fitting the engine with an external exhaust gas recirculation conduit between the exhaust manifold outlet and intake manifold; and
recirculating at least a portion gases from the exhaust outlet to the intake manifold during brake operation to increase charging of the cylinders of the engine prior to the compression stroke.

25. The method as claimed in claim 24, wherein the exhaust is restricted downstream of the exhaust manifold outlet.

26. The method as claimed in claim 25, wherein the exhaust is restricted by placing a turbocharger downstream of the exhaust outlet.

27. The method as claimed in claim 26, wherein the exhaust is restricted between the exhaust manifold outlet and a turbocharger.

28. The method as claimed in claim 24, wherein the exhaust gas is cooled between the exhaust manifold outlet and the intake manifold.

29. The method as claimed in claim 24, wherein the exhaust gas is recirculated when speed of the turbocharger exceeds a preset value, temperature of exhaust exceeds a preset amount or pressure of exhaust exceeds a preset amount.

30. The method as claimed in claim 29, wherein the preset values of the speed of the turbocharger, temperature of exhaust and pressure of exhaust are stored and compared to actual speed of the turbocharger, temperature of exhaust and pressure of exhaust.
